(19) United States
(12) Patent Application Publication
(10) Pub. No.: US 2012/0011759 A1
(43) Pub. Date: Jan. 19, 2012

(54) RECOIL-REDUCING SHOOTING REST

(75) Inventors: Dennis Cauley, Boonville, MO (US); Tim Morrow, Jefferson City, MO (US)

(73) Assignee: Battenfeld Technologies, Inc., Columbia, MO (US)

(21) Appl. No.: 13/009,389

(22) Filed: Jan. 19, 2011

Related U.S. Application Data
(63) Continuation of application No. 10/865,595, filed on Jun. 10, 2004, now Pat. No. 8,011,129.
(60) Provisional application No. 60/478,557, filed on Jun. 13, 2003.

(51) Int. Cl. F41C 27/00; B23P 11/00

(52) U.S. Cl. 42/94; 29/428

(57) ABSTRACT

A shooting rest supports a firearm and reduces recoil energy of the firearm. The shooting rest has a rear support and a front support for supporting the firearm and a frame connecting the rear support and the front support. The frame supports at least one weight to reduce the amount of recoil energy felt by a shooter.

### CROSS-REFERENCE TO RELATED APPLICATIONS

This application is a non-provisional of U.S. Provisional patent application Ser. No. 60/478,557, filed Jun. 13, 2003. The entire text of which is hereby incorporated herein by reference.

### BACKGROUND OF THE INVENTION

This invention relates generally to a firearm shooting rest, and more particularly to a shooting rest that reduces the amount of recoil energy transmitted to a shooter.

The firearms shooting sports are often associated with the sometimes painful recoil that results from shooting the firearm. Recoil from large caliber firearms can cause a shooter to flinch, or jerk the firearm trigger, in anticipation of the shock to the shooter's upper body. Flinching, or jerking the trigger, in anticipation of recoil is a common negative factor in a shooter's accuracy. Recoil can be described as the equal and opposite reaction to the momentum of an ammunition cartridge's projectile (bullet) and gunpowder charge upon firing of the cartridge. This momentum is imparted to the firearm, causing it to travel in the opposite direction of the fired bullet. The resulting energy, or recoil energy, of the firearm can be calculated using the following equation derived from the Law of Conservation of Momentum:

$$Recoil Energy ( ft \text{-} lbs ) = \frac{( \begin{matrix}Bullet Weight \times Bullet Velocity + \\ 4700 \times Gunpowder Weight\end{matrix} ) \hat{} 2}{64.348 \times Firearm Weight}$$

Where 4700 is the velocity of the gases generated by the burning gunpowder and 64.348 is a correction factor for the acceleration of gravity.

As can be seen by the above equation, increasing the Firearm Weight will result in a decreased Recoil Energy. As is common to the art of firearms manufacture, large caliber, heavy recoiling firearms are designed to be heavier in weight than small caliber, low recoiling firearms for precisely this reason. The additional weight has a dampening effect on the recoil felt by the shooter.

To test the accuracy of a firearm a shooter will commonly shoot with the firearm placed atop a shooting rest, which in turn is placed atop a bench. The shooter then fires the firearm from a sitting position behind the bench. This type of arrangement eliminates shooting errors caused by the inability of the human body to hold a firearm perfectly steady and provides the steadiest, most accurate method of supporting a firearm while shooting. Shooting from the bench has the drawback of subjecting the shooter to a higher degree of “effective recoil.” Actual recoil energy of the firearm does not increase by shooting from the bench, but more of the recoil energy is transferred to the shooter in a sitting position than in a standing position. The standing position allows the entirety of the shooter's body to flex and partially absorb the recoil energy. In the sitting position only the torso (shoulder to waist) of the shooter is available to flex and absorb the recoil. Because of the higher “effective recoil” when firing from a sitting position, shooting a large caliber, heavy recoiling firearm from a bench can create an unpleasant experience when firing more than a few rounds. It is common for a shooter to fire upwards of twenty rounds when zeroing, or sighting-in, especially in the case of rifles and shotguns using telescopic sights.

From this point forward the discussion of firearms will pertain specifically to long arms (e.g., rifles and shotguns) although many of the principles discussed could be applied to other types of firearms.

This invention relates to a method of reducing recoil experienced by the shooter without requiring modification to the firearm. Several devices are currently available that serve as a means of supporting a firearm on a bench while reducing recoil. These recoil-reducing shooting rests differ from traditional shooting rests in that the traditional rests do nothing to absorb recoil. A traditional shooting rest supports and steadies the firearm, but does not restrain it. A recoil-reducing shooting rest may employ any of a multitude of methods to dampen, or absorb the recoil energy. Typically these devices consist of a base unit with a moveable carriage, with the firearm resting on and affixed to the carriage. The carriage is moveably attached to the base to allow linear motion relative to the base along a path parallel to the direction of firearm recoil. Springs, pneumatic cylinders, elastic bands or other methods with which to slow, or dampen, the force and energy of the recoiling firearm, restrain the carriage, and the firearm affixed to the carriage, from free travel relative to the base. Reference may be made to U.S. Pat. No. 5,811,720, incorporated by reference herein for all purposes, for additional background information relating to existing recoil-reducing shooting rests.

The present invention reduces recoil by adding weight to the shooting rest. The shooting rest is a rigid structure. Therefore, when the firearm is fired, the firearm and shooting rest can be considered as a single unit subjected to the firearm's recoil energy. Mathematically, the weight of the shooting rest can be added to the weight of the firearm to yield a total Firearm Weight as used in the Recoil Energy equation. Since total Firearm Weight is inversely proportional to recoil energy, adding more weight to the shooting rest results in a corresponding reduction in recoil energy. The recoil-reducing shooting rest of the present invention is designed to accept 25 lb. bags of lead shot to increase the weight of the unit. Lead shot was selected for its availability to the typical shooter, uniformity of packaging and ease of portability.

### SUMMARY OF THE INVENTION

The objectives of the present invention include one or more of the following:

1) A shooting rest that provides recoil reduction for heavy recoiling firearms;

2) Recoil reduction in the simplest manner possible;

3) A rigid shooting rest to withstand the energy of heavy recoiling firearms;

4) A stable shooting rest;

5) A shooting rest with few moving parts;

6) A quality product with minimal cost

The present invention is designed to reduce the recoil energy experienced by a shooter when shooting heavy recoiling rifles and shotguns from a sitting position at a bench while providing a solid, steady support for the firearm. In one embodiment, the Recoil-Reducing Shooting Rest is of a rigid design and constructed of steel tubing and sheet metal. The rest includes a stationary Rear Support for the buttstock of a firearm, an adjustable Front Support for the forend of the firearm, a stabilizing Frame connecting the Rear and Front Supports and a formed sheet metal Holder located in the center of the frame. The purpose of the holder is to hold weight added by the shooter. In one embodiment, the holder is designed to hold up to four 25 lb. bags of lead shot or other suitable material. The weight of the lead shot reduces recoil energy generated by offering resistance to the rearward movement of the firearm and Shooting Rest upon discharge of the firearm.

Other objects and features will be in part apparent and in part pointed out hereinafter.

### BRIEF DESCRIPTION OF THE DRAWINGS

FIG. 1 is a perspective view of one embodiment of a recoil-reducing shooting rest of the present invention with a rifle mounted in a firing position.

FIG. 2 is a side view of the shooting rest of FIG. 1.

FIG. 3 is a top view of the shooting rest of FIG. 1.

FIG. 4 is a detailed section view of a portion of the shooting rest taken along the plane including line 4-4 of FIG. 3.

FIG. 5 is a section view taken along the plane including line 5-5 of FIG. 3.

Corresponding parts are designated by corresponding reference numbers throughout the drawings.

### DESCRIPTION OF THE PREFERRED EMBODIMENT

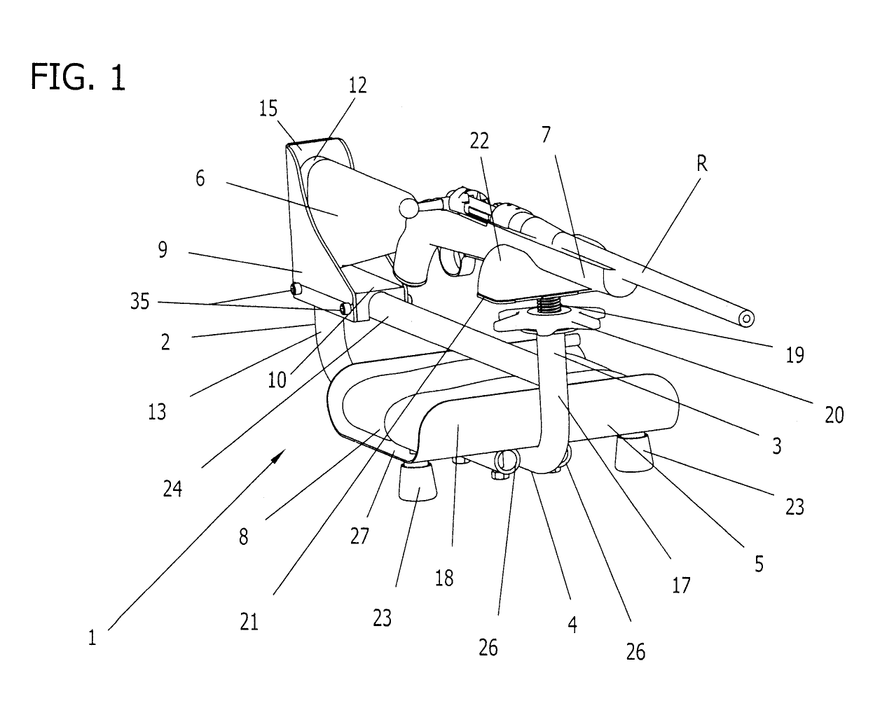

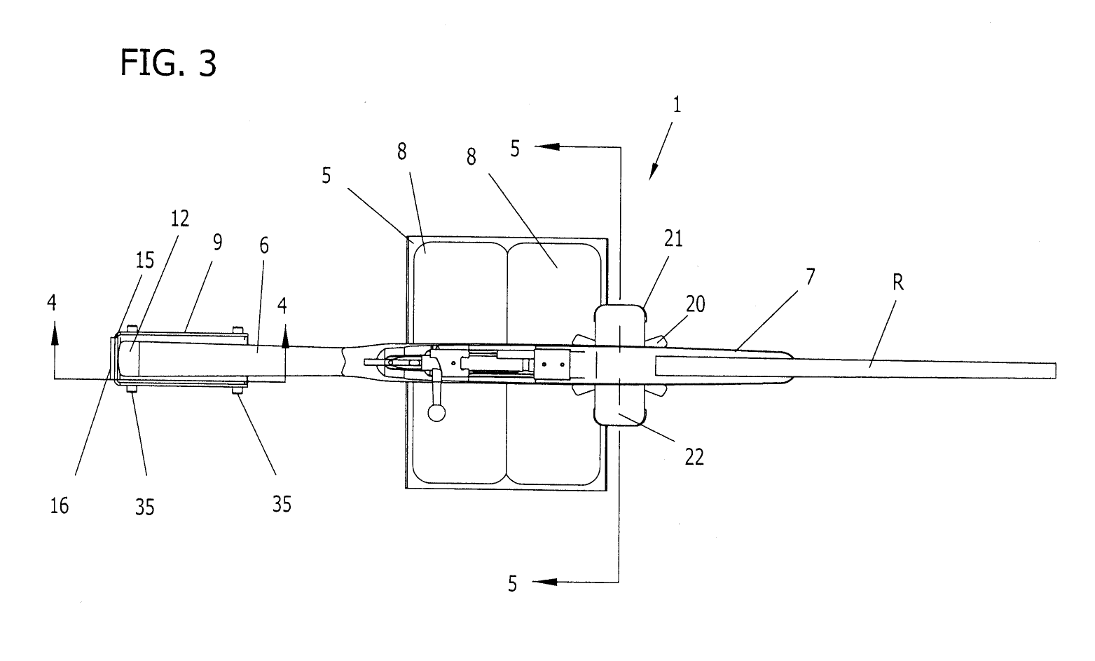

FIGS. 1 through 3 illustrate one embodiment of the present invention from varying angles with a firearm (rifle) R placed atop the unit in the shooting position. The Recoil-reducing Shooting Rest (Shooting Rest), generally designated 1, includes four main subsystems, namely, a Rear Support 2, a Front Support 3, a Frame 4 and a Holder 5. The Rear Support 2 supports a buttstock 6 of the rifle R and the Front Support 3 supports the forend 7 of the rifle. The Frame 4 connects the Rear Support 2, Front Support 3 and Holder 5 so that the Shooting Rest 1 is a single, rigid unit.

In one embodiment the Frame 4 is constructed of steel tubing and comprises a Rear Vertical Section 13, a Horizontal Base Section 14, a Front Vertical Section 17, and a Horizontal Support Member 24. The Frame 4 provides a rigid infrastructure to the Shooting Rest 1 by joining all the subsystems in a single unit. Preferably, the Rest 1 has three points of contact with a bench or other flat surface but it will be understood that the Shooting Rest may have more or less than three points of contact with the bench without departing from the scope of this invention. In the illustrated embodiment, a Rear Foot 25 is located on the Horizontal Base Section 14 of the Frame 4, generally near the rear of the Shooting Rest 1 and two Front Feet 23 are located toward the outside edges of the Holder 5. A three-point contact, or tripod arrangement, provides the most inherently stable and self-leveling configuration of the Shooting Rest 1. The Front Feet 23 and Rear Foot 25 provide a non-marring surface for contact of the Shooting Rest 1 with the bench and also provide a large coefficient of friction between the Shooting Rest and the bench to minimize movement of the Shooting Rest during firearm discharge. The Rear Foot 25 is threadably engaged to the Horizontal Base Section 14. The threaded engagement allows for elevation adjustment for the rear portion of the Rest 1. The Front Feet 23 are attached to the Holder 5 by conventional fasteners (e.g. sheet metal screws not shown).

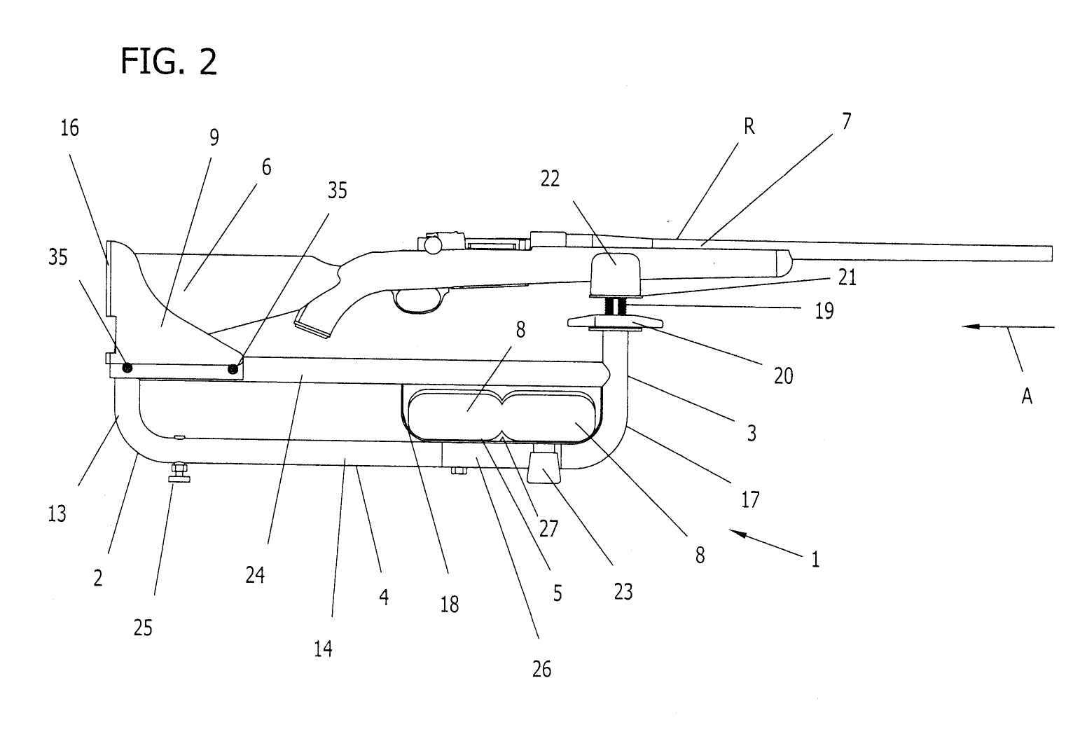

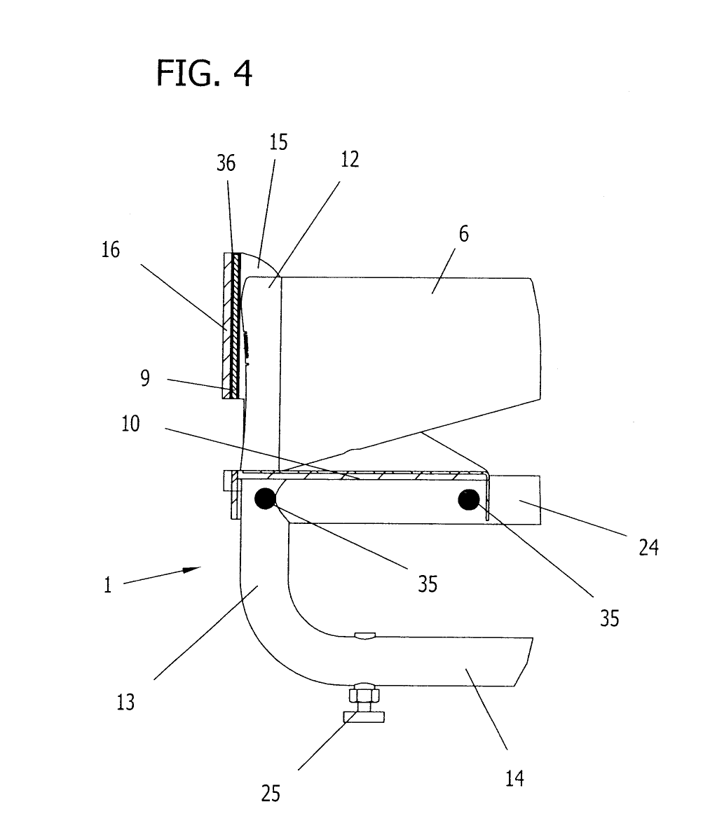

The Rear Support 2 supports the rifle buttstock 6 and provides the main transfer point of the recoil energy from the rifle R to the Frame 4 of the Shooting Rest 1. In the illustrated embodiment, the Rear Support 2 consists of a Buttstop 9, Toe Plate 10 and a Recoil Shoulder Pad 16. As seen in FIG. 4 the rifle buttstock 6 rests atop the Toe Plate 10 with the rear surface of the buttstock, called a buttplate 12, contacting the inside surface 15 of the Buttstop 9. In one embodiment, the Buttstop 9 is formed from sheet metal and has two side panels and a rear panel that contacts the rear surface of the rifle buttstock 6. The Buttstop 9 is rigidly connected to the Toe Plate 10, the Rear Vertical Section 13 of the Frame 4, and the Horizontal Support Member 24 of the Frame 4. In one embodiment, the Buttstop 9 and Toe Plate 10 are fixed to the Rear Vertical Section 13 and Horizontal Support Member 24 of the Frame 4 by threaded fasteners (e.g., bolts 35 in FIG. 4). Firing the rifle R will cause the rifle to translate in a rearward direction, as indicated by arrow A in FIG. 2. With the rifle buttplate 12 in contact with the inside surface 15 of the Buttstop 9 the recoil energy of the rifle R will be transferred to the Buttstop 9, and therefore to the entire Shooting Rest 1. The Recoil Pad 16 comprises a resilient foam pad attached (e.g. sewn) to a thin nylon sleeve 36 that fits over the Buttstop 9 to provide a soft, comfortable surface to the shooter's shoulder (FIG. 4). The nylon sleeve 36 covers the inside surface 15 of the Buttstop 9 to provide a non-marring surface for contact with the Buttplate 12 of the firearm R.

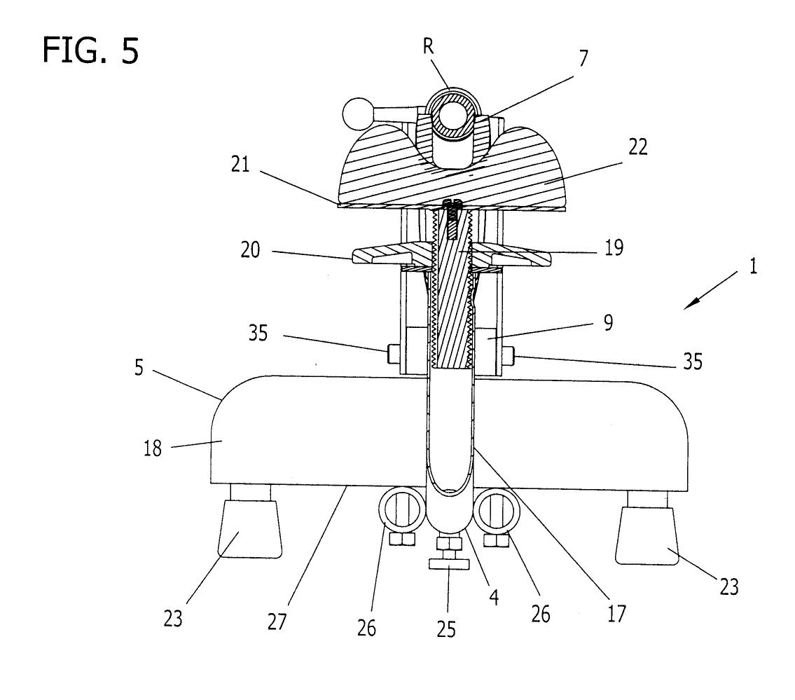

Referring to FIGS. 1, 2, and 5, the Front Support 3 functions as a vertically adjustable (elevation adjustment) support for the rifle's forend 7. The specific component parts for the Front Support 3 are typical to other shooting rests designs known in the art. As shown in FIG. 5, a cylindrical, threaded Ram 19 is removably inserted into an open end of the Front Vertical Section 17 of the Frame 4. A threaded Adjustment Wheel 20 rests atop the end of the Front Vertical Section 17 of the Frame 4 and is threadably engaged with the Ram 19. Rotating the Adjustment Wheel 20 causes the Ram 19 to translate vertically in relation to the Front Vertical Section 17 of the Frame 4. A Cradle 21 is rigidly joined to the top surface of the Ram 19. In one embodiment, the Cradle 21 is a stamped sheet metal platform that supports a bag 22 filled with sand, or other particulate media, that is shaped to fit the typical contour of a rifle forend 7. When the Adjustment Wheel 20 is rotated, the Ram 19 vertically moves causing corresponding movement of the Cradle 21 to adjust the vertical position of the rifle forend 7 to a desired position.

In one embodiment, the Holder 5 is formed of sheet metal and is rigidly connected to the Horizontal Base Section 14 of the Frame 4. Two Holder Support Tubes 26 are welded to Horizontal Section 14 to add support and stability to the Holder 5 by preventing it from rotating about the Horizontal Section. In the illustrated embodiment, the Holder 5 has a generally U-shaped cross-section with front and back Lips 18 that curve upward from a bottom surface 27 of the holder. The Holder 5 provides a stable platform to receive weights 8 placed on the Shooting Rest R by the shooter and a structure for the attachment of the Front Feet 23 to the Shooting Rest 1. It will be understood that the Holder 5 may comprise other structures for supporting the weights 8 on the Frame 4 or that the weights may be attached directly to the Frame without departing from the scope of this invention. In the illustrated embodiment, the weights 8 are in the form of 25 lb. bags of lead shot due to their availability to a typical marksman and ease of portability. However, other forms of additional weight may be used without departing from the scope of this invention. In the illustrated embodiment, the Holder 5 is designed to hold up to four bags of lead shot 8, but only two bags are shown loaded on the Holder. The lips 18 are sized to prevent the bags of lead shot 8 from shifting during rifle discharge.

All subsystems of the Shooting Rest 1 are joined via bolted or welded connections, for example, to form a rigidly constructed unit. With a weight of approximately 15 lbs., an overall length of approximately 25 inches and a height of approximately 13 inches the Shooting Rest 1 is easily portable. The only movable or adjustable components of the Shooting Rest 1 are the Front Support 3 and the Rear Foot 25. The Front Support 3 will adjust vertically to allow elevation sighting adjustments of the firearm R. The Rear Foot 25 also adjusts vertically to allow for leveling of the Rest 1 and elevation sighting adjustments of the firearm R.

Recoil energy is reduced when, according to the Law of Conservation of Momentum, the recoiling rifle encounters a greater opposing weight than merely the weight of the rifle alone. In the illustrated embodiment, the Holder 5 supports this opposing weight (represented by the four 25 lb. bags of Lead Shot 8), so that the Shooting Rest 1 reduces recoil energy when the firearm R is discharged.

The recoil-reducing aspect of the Shooting Rest 1 is created by adding weight to the unit to increase resistance to the recoil of the firearm. According to the Law of Conservation of Momentum, written below in terms pertaining to the discussion, the Recoil Energy of the firearm can be calculated from the following equation:

$$Recoil Energy ( ft \text{-} lbs ) = \frac{( \begin{matrix}Bullet Weight \times Bullet Velocity + \\ 4700 \times Gunpowder Weight\end{matrix} ) \hat{} 2}{64.348 \times Firearm Weight}$$

Where 4700 is the velocity of the gases generated by the burning gunpowder and 64.348 is a correction factor for the acceleration of gravity.

Increasing the Firearm Weight in the above-stated formula will result in a decreased Recoil Energy. When the firearm is discharged, the firearm and the Recoil-reducing Shooting Rest 1 can be considered as a single unit subjected to the firearm's recoil. Mathematically, the weight of the shooting rest 1 can be added to the weight of the firearm R to yield a total Firearm Weight as used in the Recoil Energy equation. The more weight added to the rest 1, the higher the reduction in recoil. The Holder 5 is designed to accept up to four 25 lb. bags of lead shot 8 but other types of weights could be used to further increase the weight of the Shooting Rest 1. Twenty-five lb. bags of shot 8 are commonly available to the typical shooter and provide an easily portable system of weight addition for the Shooting Rest. Typically, the recoil energy of a firearm can be reduced by up to 90% by adding weight to the Shooting Rest 1. The amount of weight needed to provide a certain percentage of recoil reduction is dependant on the caliber and size of the firearm used on the Shooting Rest 1.

The general steps in the process of using the Shooting Rest 1 comprise:

1) Placing the Shooting Rest 1 on top of a relatively flat table or bench.

2) Placing weights 8 on the Holder 5 of the Shooting Rest 1.

3) Placing the firearm R atop the Shooting Rest 1 in such a manner that the buttstock 6 of the firearm rests in the Rear Support 2 while the Front Support 3 cradles the forend 7 of the firearm.

4) The Front Support 3 and/or Rear Foot 25 may be vertically adjusted to level the rest 1 or make elevation sighting adjustments of the firearm R.

5) The shooter will take a sitting position behind the Shooting Rest 1 and firearm R with the Rear Support 2 of the Shooting Rest closest to the shooter. The Shooting Rest 1 will be oriented such that an imaginary line connecting the Rear Support 2 and the Front Support 3 will be perpendicular to an imaginary line connecting the shooter's shoulders.

6) The shooter's shoulder will be placed against the Shoulder Rest 16 attached to the Rear Support 2.

7) The shooter will place both hands on the firearm R in a comfortable shooting position.

8) The shooter will pull the buttstock 6 of the firearm R towards the shoulder so as to make complete and firm contact with the inside surface 15 of the Rear Support 2.

9) The shooter will fire, or discharge, the firearm R.

10) Discharging the firearm R will cause the firearm to translate linearly, or recoil, in a rearward direction.

11) With the recoiling firearm R in firm contact with the Rear Support 2 the recoil energy of the firearm is transferred to the Shooting Rest 1.

12) The Shooting Rest 1 will translate linearly, or recoil, in a rearward direction. Due to the resistance offered by the weights 8 added to the Shooting Rest, the Shooting Rest will recoil with a significantly reduced velocity and energy than the firearm alone.

13) With the shooter in firm contact with the Shooting Rest 1 the shooter's upper body will in turn absorb the reduced recoil energy of the Shooting Rest.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense. For example, the Frame 4 may comprise materials other than steel tubing. Also, the Holder 5 may be an integral part of the Frame 4 or the Holder may be eliminated so that the weights 8 are supported directly on the Frame. Further, the weights 8 could be separate components attached to the Frame 4 or the weights may be integral with the Frame so that the weight of the Shooting Rest 1 is increased and the recoil energy transferred to a shooter is decreased.

In view of the above, it will be seen that the several objects of the invention are achieved and other advantageous results attained.

1-20. (canceled)

21. A shooting rest for supporting a firearm having a rear portion and a first portion forward of the rear portion, the shooting rest comprising:
a rear support positioned to carry the rear portion of the firearm;
a front support coupled to the rear support and positioned to carry the first portion of the firearm;
a support member coupled to at least one of the rear support or the front support, the support member including a surface for carrying a removable weight; and
an inhibiting member coupled to at least one of the rear support or the support member, the inhibiting member configured to inhibit rearward movement of the firearm relative to the rear support.

22. The shooting rest of claim 21 wherein at least a portion of the support member is positioned between the front and rear supports.

23. The shooting rest of claim 21 wherein the support member further comprises first and second portions projecting from the surface and positioned to retain the removable weight on the support member.

24. The shooting rest of claim 21 wherein the inhibiting member comprises a buttstop.

25. The shooting rest of claim 21 wherein the inhibiting member is positioned to contact the rear portion of the firearm.

26. A shooting rest for supporting a firearm having a first portion and a second portion rearward of the first portion, the shooting rest comprising:
a first support for supporting the first portion of the firearm;
a second support for supporting the second portion of the firearm, the second support being coupled to and spaced apart from the first support;
a support member for supporting a supplemental weight, the support member being configured to retain the supplemental weight on the support member, the support member being positioned at least partially between the first and second supports; and
an inhibiting member for inhibiting rearward movement of the firearm relative to the rear support, the inhibiting member being coupled to at least one of the second support or the support member.

27. The shooting rest of claim 26 wherein the support member has a U-shaped configuration.

28. The shooting rest of claim 26 wherein the support member comprises a generally flat surface and first and second portions projecting from the surface, and wherein the first and second portions are positioned to retain the supplemental weight on the support member.

29. The shooting rest of claim 26 further comprising a frame connecting the first and second supports, and wherein the support member is attached to the frame.

30. The shooting rest of claim 26 further comprising a frame connecting the first and second supports, and wherein the support member is a portion of the frame.

31. A shooting rest for supporting a firearm having a first portion and a rear portion rearward of the first portion, the shooting rest comprising:
a frame;
a front support coupled to the frame, the front support being configured to carry the first portion of the firearm;
a rear support coupled to the frame, the rear support being configured to carry the rear portion of the firearm and inhibit rearward movement of the firearm relative to the rear support; and
means for supporting a removable weight, the means for supporting being coupled to the frame.

32. The shooting rest of claim 31 wherein the means for supporting the removable weight comprise a support member having a U-shaped configuration.

33. The shooting rest of claim 31 wherein the means for supporting the removable weight comprise a support member having a generally flat surface and first and second portions projecting from the surface, and wherein the first and second portions are positioned to retain the removable weight on the support member.

34. The shooting rest of claim 31 wherein the means for supporting the removable weight comprise a support member configured such that the removable weight can be placed on the support member while the front support carries the first portion of the firearm and the rear support carries the rear portion of the firearm.

35. The shooting rest of claim 31 wherein the rear support comprises a buttstop to inhibit rearward movement of the firearm relative to the rear support.

36. A method of manufacturing a shooting rest for supporting a firearm having a first portion and a second portion rearward of the first portion, the method comprising:
coupling a front support to a frame with the front support positioned to support the first portion of the firearm;
attaching a rear support to the frame with the rear support positioned to support the second portion of the firearm;
coupling a support member to the frame with a surface of the support member configured to carry a removable weight; and
attaching an inhibiting member to at least one of the rear support or the frame with the inhibiting member positioned to inhibit rearward movement of the firearm relative to the shooting rest.

37. The method of claim 36 wherein coupling the support member comprises positioning the support member between the front and rear supports.

38. The method of claim 36 wherein coupling the support member comprises attaching a support member having a U-shaped configuration to the frame.

39. The method of claim 36 wherein coupling the support member comprises attaching to the frame a support member having first and second portions projecting from the surface.

40. The method of claim 36 wherein attaching the inhibiting member comprises coupling a buttstop to the rear support.

41. The method of claim 36 wherein attaching the inhibiting member comprises positioning the inhibiting member to contact the second portion of the firearm.

42. The method of claim 36 wherein attaching the inhibiting member comprises coupling the inhibiting member to the rear support.
